(19) United States
(12) Patent Application Publication
(10) Pub. No.: US 2026/0092792 A1
(43) Pub. Date: Apr. 2, 2026

(54) METHOD AND DEVICE FOR CREATING A SECOND DIGITAL MAP

(71) Applicant: Robert Bosch GmbH, Stuttgart (DE)

(72) Inventors: Jan Rohde, Dettingen Unter Teck (DE); Philipp Rasp, Reusten (DE)

(21) Appl. No.: 19/333,475

(22) Filed: Sep. 19, 2025

(30) Foreign Application Priority Data
Sep. 27, 2024 (DE) 10 2024 209 380.7

(51) Int. Cl. G01C 21/00

(52) U.S. Cl. CPC G01C 21/387; G01C 21/3841

(57) ABSTRACT

A method and device for creating a second digital map. The method includes: evaluating processes previously used to create map data, the map data representing a first digital map, the processes for creating the map data using first surrounding region data value sets, the first surrounding region data value sets each representing a first surrounding region of first vehicles; determining parameters based on the previously evaluated processes depending on the used first surrounding region data value sets, the parameters representing a qualitative contribution of the respective first surrounding region data value sets to the creation of the map data; generating and providing a signal for requesting second surrounding region data value sets that meet predetermined criteria depending on the parameters, the second surrounding region data value sets each representing a second surrounding region of second vehicles; receiving the second surrounding region data value sets; creating the second digital map.

### CROSS REFERENCE

The present application claims the benefit under 35 U.S.C. § 119 of Germany Patent Application No. DE 10 2024 209 380.7 filed on Sep. 27, 2024, which is expressly incorporated herein by reference in its entirety.

### FIELD

The present invention relates, inter alia, to a method for creating a second digital map, in which processes previously used to create map data are evaluated, and parameters are determined based on the previously evaluated processes. Subsequently, a signal for requesting second surrounding region data value sets that meet predetermined criteria depending on the parameters is generated and provided, and the second digital map is created and provided depending on the second surrounding region data value sets.

### SUMMARY

According to an example embodiment of the present invention, the method for creating a second digital map comprises a step of evaluating processes previously used to create map data, the map data representing at least one first digital map, the processes for creating the map data using first surrounding region data value sets, the first surrounding region data value sets each representing a first surrounding region of first vehicles, and a step of determining parameters based on the previously evaluated processes depending on the respectively used first surrounding region data value sets, the parameters representing a qualitative contribution [e.g., according to predefined/mathematically verifiable criteria] of the respective first surrounding region data value sets to the creation of the map data. The method further comprises a step of generating and providing a signal for requesting second surrounding region data value sets that meet predetermined criteria depending on the parameters, the second surrounding region data value sets each representing a second surrounding region of second vehicles; a step of receiving the second surrounding region data value sets; a step of creating the second digital map depending on the second surrounding region data value sets; and a step of providing the second digital map.

A first or second digital map is understood to mean a map that is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein surrounding region features comprised by the radar map are stored along with a radar signature. A further map layer comprises, for example, a lidar map, wherein surrounding region features comprised by the lidar map are stored along with a lidar signature.

In one example embodiment of the present invention, the map is designed as a highly accurate map. The highly accurate map is in particular designed in such a way that it is suitable for the navigation of an automated vehicle. This is understood to mean, for example, that the highly accurate map is designed to determine a highly accurate position of this automated vehicle by comparing stored surrounding region features with detected sensor data values of this automated vehicle. For this purpose, the highly accurate map, for example, comprises said surrounding region features along with highly accurate position specifications (coordinates). In this context, a map is in particular understood to mean a globally accurate map.

A highly accurate position is understood to mean a position which is accurate within a specified coordinate system, e.g., WGS84 coordinates, in such a way that this position does not exceed a maximum permitted uncertainty. The maximum uncertainty may depend on the surrounding region, for example. Furthermore, the maximum uncertainty can depend, for example, on whether a vehicle is operated manually or in a semi-, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of about 10 centimeters.

An automated vehicle is understood to mean a semi-, highly or fully automated vehicle according to one of SAE levels 1 to 5 (see standard SAE J3016).

Creating the digital map is understood to mean, for example, that surrounding region features, which are comprised by the first and/or second surrounding region data value sets, are newly integrated into a base map according to their position and/or corresponding surrounding region features already comprised by the base map are removed or adjusted. Here, a base map is understood to mean in particular a (first) digital map (as described above). The digital map is created in particular by means of the aforementioned processes, which are carried out sequentially and/or at least partially in parallel. For example, individual processes are designed to organize, filter and analyze the relevant data. This includes, for example, processing raw data to remove noise and extract accurate information. The data can also be used to identify and classify objects such as road signs, pedestrians, vehicles and other road users. In addition, the data can be used to create precise 3D models of the surrounding region, which are used for map generation. Digital maps are created based on the processed data. This can comprise creating vector or raster maps that include roads, buildings, traffic signs, traffic lights, and other features. The maps can also include additional information such as speed limits, traffic density and other relevant data. Map generation can also comprise the integration of different data types and the creation of maps at different scales and formats to meet the requirements of different navigation applications.

According to an example embodiment of the present invention, the first and/or second surrounding region data value sets are detected by means of a surrounding region sensor system. A surrounding region sensor system is understood to mean at least one video sensor and/or at least one radar sensor and/or at least one lidar sensor and/or at least one ultrasonic sensor and/or at least one further sensor that is designed to detect the surrounding region of a vehicle, in particular the surrounding region features of this surrounding region, in the form of surrounding region data values. In one possible embodiment, the surrounding region sensor system comprises, for example, a computing unit (processor, working memory, hard drive) with suitable software and/or is connected to such a computing unit for this purpose.

A surrounding region feature is understood here to mean, for example, an infrastructure feature (roadway boundary lines, guardrails, etc.) and/or a traffic sign (road signs, traffic lights, etc.) and/or a structural feature (buildings, bridges, tunnels, etc.) and/or a further feature that can be detected by means of a surrounding region sensor system.

The first and/or second vehicles are understood to mean a plurality of vehicles (vehicle fleet), each of which is equipped with an appropriate surrounding region sensor system. Furthermore, these vehicles comprise transmitting and receiving units in order to transmit the detected first surrounding region data value sets, in particular directly or indirectly to the device according to the present invention.

According to an example embodiment of the present invention, the determined parameters represent, for example, quality properties of the fleet data (indicators from the mapping pipeline [see above-mentioned processes when creating the map], hypothesis rejection rate, false detection rate [e.g., during video feature fusion], statistical information about occlusion effects in the sensor field of view and traffic information in the region of the first vehicles, false positive rate, misclassification rate, number of discarded measurements, detected radar interference, etc.) and/or effects of the first surrounding region data value sets on the map quality, e.g., based on statistics from the fusion of map attributes (map features) and/or on a quality assessment of the map and/or based on a model that describes the relationship between the processes when creating the map, and the map quality.

A qualitative contribution of all or individual parameters is understood, for example, to be a digital description that represents the relevant impact on the map quality according to predefined criteria.

The method according to the present invention advantageously achieves the object of providing a method for creating a (second) digital map. The aforementioned object may be achieved by means of the method according to the present invention in particular in that parameters are determined based on evaluated processes depending on the respectively used first surrounding region data value sets and then a signal for requesting second surrounding region data value sets that meet predetermined criteria depending on the parameters is generated and provided. This allows a defined map quality to be achieved with as little fleet data (surrounding region data value sets) as possible. This results in lower costs for the required fleet data and makes operating the map service more cost-efficient, as the amount of fleet data required to achieve a given quality level of the map product has a direct impact on the profitability of the map service's business model. This is where the method according to the present invention comes in, allowing the selection and request of only that fleet data (surrounding region data value sets) which contributes maximally to map quality. This makes it possible to specifically request (only) the fleet data that makes the greatest contribution to map quality and use it to create the (second) digital map.

According to a possible embodiment of the present invention, the at least one mapping vehicle corresponds to at least one of the second vehicles.

Preferably, according to an example embodiment of the present invention, the signal represents a trajectory for the mapping vehicle and/or commands for issuing driving instructions.

For this purpose, the signal represents, for example, an instruction for automated control and/or corresponding information that can be output in the at least one mapping vehicle by means of a suitable output unit (screen, loudspeaker, etc.).

Preferably, according to an example embodiment of the present invention, the parameters additionally comprise a location of the first surrounding region and/or a timestamp of the first surrounding region data value sets. Furthermore, the parameters can additionally or alternatively represent one or more of the following information: weather, traffic information, fleet ID, road type, perception information about the driving scenario, average speeds of the first vehicles, presence of preceding and/or neighboring vehicles, statistical information about occlusion effects in the sensor field of view, etc.

According to an example embodiment of the present invention, the device, in particular a computing unit, is configured to perform all steps of the method for creating a (second) digital map. A computing unit is understood to mean, for example, a server or a server network or a cloud.

According to an example embodiment of the present invention, the device or computing unit comprises a processor, working memory, storage medium, and suitable software in order to perform the method according to one of the method embodiments. Furthermore, the device comprises an interface in order to transmit and receive data values by means of a wired and/or wireless connection, for example with corresponding devices of vehicles (control units, communication devices, surrounding region sensor system, navigation system, etc.) and/or further off-board devices (server, cloud, etc.).

Furthermore, the present invention provides a computer program is provided, comprising commands that, when the computer program is executed by a computer, cause the computer to perform a method according to one of the method embodiments of the present invention for creating a (second) digital map. In one example embodiment of the present invention, the computer program corresponds to the software comprised by the second device.

Furthermore, a machine-readable storage medium on which the computer program is stored is provided.

Advantageous developments of the present invention are disclosed herein.

### BRIEF DESCRIPTION OF THE DRAWING

Exemplary embodiments of the present invention are shown in the FIGURE and explained in more detail in the following description.

FIG. 1 shows an exemplary embodiment of the method according to the present invention for creating a (second) digital map in the form of a flow chart.

### DETAILED DESCRIPTION OF EXAMPLE EMBODIMENTS

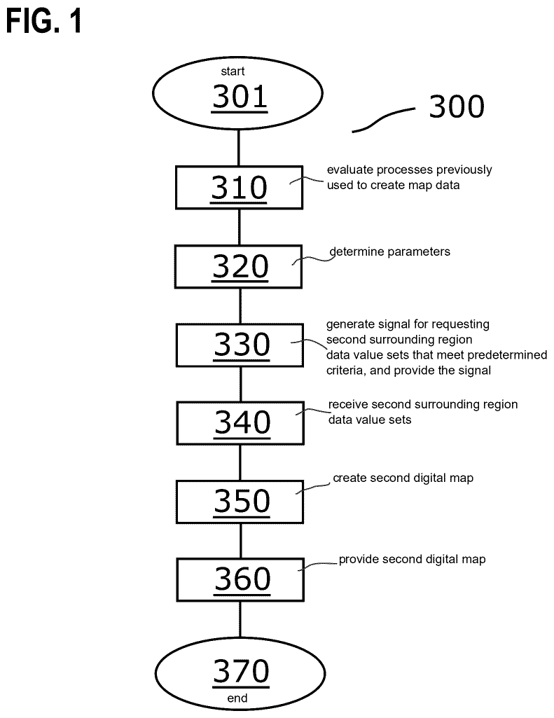

FIG. 1 shows an exemplary embodiment of a method 300 for creating 350 a second digital map.

In step 301, the method 300 starts.

In step 310, processes previously used to create map data are evaluated, the map data representing at least one first digital map, the processes for creating the map data using first surrounding region data value sets, the first surrounding region data value sets each representing a first surrounding region of first vehicles.

In step 320, parameters are determined based on the previously evaluated processes and depending on the respectively used first surrounding region data value sets. The parameters represent a qualitative contribution of the respective first surrounding region data value sets to the creation of the map data.

In step 330, a signal for requesting second surrounding region data value sets that meet predetermined criteria depending on the parameters is generated. The second surrounding region data value sets each represent a second surrounding region of second vehicles. This signal is then provided.

In step 340, the second surrounding region data value sets are received.

In step 350, the second digital map is created depending on the second surrounding region data value sets.

In step 360, the second digital map is provided.

In step 370, the method 300 ends.

What is claimed is:

1. A method for creating a second digital map, comprising the following steps:
evaluating processes previously used to create map data, the map data representing at least one first digital map, the processes for creating the map data using first surrounding region data value sets, the first surrounding region data value sets each representing a first surrounding region of first vehicles;
determining parameters based on the previously evaluated processes depending on the used first surrounding region data value sets, the parameters representing a qualitative contribution of the respective first surrounding region data value sets to the creation of the map data;
generating and providing a signal for requesting second surrounding region data value sets that meet predetermined criteria depending on the parameters, the second surrounding region data value sets each representing a second surrounding region of second vehicles;
receiving the second surrounding region data value sets;
creating the second digital map depending on the second surrounding region data value sets; and
providing the second digital map.

2. The method according to claim 1, wherein the signal is configured to be received by at least one mapping vehicle for detecting the requested second surrounding region data value sets according to the predetermined criteria.

3. The method according to claim 1, wherein the signal represents a trajectory for the mapping vehicle and/or commands for issuing driving instructions.

4. The method according to claim 1, wherein the parameters additionally include a location of the first surrounding region and/or a timestamp of the first surrounding region data value sets.

5. A device comprising:
a computing unit configured to create a second digital map by performing the following steps including:
evaluating processes previously used to create map data, the map data representing at least one first digital map, the processes for creating the map data using first surrounding region data value sets, the first surrounding region data value sets each representing a first surrounding region of first vehicles,
determining parameters based on the previously evaluated processes depending on the used first surrounding region data value sets, the parameters representing a qualitative contribution of the respective first surrounding region data value sets to the creation of the map data,
generating and providing a signal for requesting second surrounding region data value sets that meet predetermined criteria depending on the parameters, the second surrounding region data value sets each representing a second surrounding region of second vehicles,
receiving the second surrounding region data value sets,
creating the second digital map depending on the second surrounding region data value sets, and
providing the second digital map.

6. A non-transitory machine-readable storage medium on which is stored a computer program including commands for creating a second digital map, the commands, when executed by a computer, causing the computer to perform the following steps:
evaluating processes previously used to create map data, the map data representing at least one first digital map, the processes for creating the map data using first surrounding region data value sets, the first surrounding region data value sets each representing a first surrounding region of first vehicles;
determining parameters based on the previously evaluated processes depending on the used first surrounding region data value sets, the parameters representing a qualitative contribution of the respective first surrounding region data value sets to the creation of the map data;
generating and providing a signal for requesting second surrounding region data value sets that meet predetermined criteria depending on the parameters, the second surrounding region data value sets each representing a second surrounding region of second vehicles;
receiving the second surrounding region data value sets;
creating the second digital map depending on the second surrounding region data value sets; and
providing the second digital map.
